(19) United States
(12) Patent Application Publication
(10) Pub. No.: US 2005/0091812 A1
(43) Pub. Date: May 5, 2005

(54) Machining center

(76) Inventors: Kazuyuki Hiramoto, Yomatokoriyama-shi (JP); Akihiro Mochizuki, Yamatokoriyama-shi (JP); Kazutoyo Moriguchi, Yamatokoriyama-shi (JP); Michio Watanabe, Yamatokoriyama-shi (JP)

Correspondence Address: SMITH PATENT OFFICE, 1901 PENNSYLVANIA AVENUE N W, SUITE 200, WASHINGTON, DC, 20006, US

(21) Appl. No.: 10/938,871

(22) Filed: Sep. 13, 2004

(30) Foreign Application Priority Data
Sep. 12, 2003 (JP) 2003-321909
Sep. 12, 2003 (JP) 2003-321910

(51) Int. Cl. B23B 3/16

(52) U.S. Cl. 29/35.5; 29/40

(57) ABSTRACT

There is provided a machining center capable of corresponding to both horizontal and vertical turret heads by one machine main body. The machining center includes a bed 2, a column 3 fixed on the bed 2, a saddle 4 supported by the column 3 to be movable in an X axis direction, a turret base supported by the saddle 4 to be movable in a Y axis direction, a quill 6 supported by the turret base 5 to be movable in a Z axis direction, and one of a horizontal turret head 20 and a vertical turret head 50 which are attached to the quill 6 in a selectively attachable/detachable manner, in which, on the horizontal turret head 20, a plurality of tools T are arranged to be located on a circumference whose center coincides with a quill axis C and to be parallel with the quill axis C, and on the vertical turret head 50, a plurality of tools are arranged to form a radial pattern in an orthogonal direction with respect to the quill axis C.

### BACKGROUND OF THE INVENTION

1. Field of the Invention

The present invention relates to a machining center having a turret head.

2. Description of the Related Art

Generally, there are two types of machining center having a turret head: a horizontal machining center adapted to process a work with the axis of a tool being pointed in a horizontal direction (for example, refer to Japanese Patent Application Laid-open No. Hei 6-134640), and a vertical machining center adapted to process a work with the axis of a tool being pointed in a vertical direction (for example, refer to Japanese Utility Model Application Laid-open No. Hei 9-529), and each of them is adopted according to the shape of work and the type of processing such as a hole, groove, surface, and the like.

Meanwhile, in the case where the horizontal and vertical machining centers are installed respectively by the user side, there is a problem that the installation space becomes large and the installation cost increases. Further, in the case where the horizontal and vertical machining centers are manufactured respectively by the maker side, there is a problem that the manufacturing cost becomes high.

Further, depending on the size of parts and the contents of processing work, a significantly small (desktop size) machining center has been demanded. On the other hand, in the case of the conventional horizontal machining center, tools are mounted to form a radial pattern on the outer peripheral surface of a polygonal turret head, and further the machining center is configured to perform processing work while moving the turret head in the direction of the radial pattern. Therefore, it is not a suitable configuration for the case where the installation space of the entire machine is reduced.

### SUMMARY OF THE INVENTION

An object of the present invention is to provide a machining center capable of corresponding to both vertical and horizontal turret heads by one machine main body.

Another object of the present invention is to provide a machining center capable of being easily downsized to a desktop size, capable of reducing an installation space and further capable of mass-producing a small-sized work.

In a first invention, a machining center includes a bed, a column fixed on the bed, a saddle supported by the column to be movable in a left and right (X axis) direction, a turret base supported by the saddle to be movable in an up and down (Y axis) direction, a quill supported by the turret base to be movable in a forward and backward (Z axis) direction, and one of a horizontal turret head and a vertical turret head which are attached to the quill in a selectively attachable/detachable manner, in which, on the horizontal turret head, a plurality of tools a rearranged to be located on a circumference whose center coincides with a quill axis and to be parallel with the quill axis, and on the vertical turret head, a plurality of tools are arranged to form a radial pattern in an orthogonal direction with respect to the quill axis.

In the machining center according to the present invention, the horizontal turret head and the vertical turret head are selectively attachable/detachable, so that, on the user side, by changing to either the horizontal turret head or the vertical turret head according to the shape of work and the type of processing, one machine main body can correspond to both the horizontal and vertical types. Therefore, the installation space can be reduced, and the installation cost can be lowered as well.

Further, on the maker side, it is only necessary to assemble either the horizontal turret head or the vertical turret head according to the user's order, so that the machine main body can be made common, and thus the manufacturing cost can be reduced.

In one preferred embodiment of the first invention, the machining center further includes a turret shaft that is common to the horizontal turret head and the vertical turret head and supported by the quill in a manner capable of rotary indexing a predetermined position, in which either the main body of the horizontal turret head or the main body of the vertical turret head is attached to the turret shaft in a selectively attachable/detachable manner.

In the embodiment, since the horizontal and vertical turret heads themselves have a structure such that either the horizontal turret main body or the vertical turret main body is selectively attachable/detachable to the turret shaft that is common to the both, it is only necessary to additionally prepare a turret main body to which various tools are attached. Therefore, common parts can be increased, and thus further cost reduction becomes possible.

In a second invention, a machining center includes a bed, a column fixed on the bed, a saddle supported by the column to be movable in a left and right (X axis) direction, a turret base supported by the saddle to be movable in an up and down (Y axis) direction, a quill supported by the turret base to be movable in a forward and backward (Z axis) direction, and a turret head attached to the quill in a manner capable of rotary indexing a predetermined position around a quill axis, in which, on the turret head, a plurality of tools are arranged to be located on a circumference whose center coincides with a quill axis and to be parallel with the quill axis.

In the present invention, the turret head is attached in a manner capable of rotary indexing a predetermined position to the quill that is supported to be relatively movable in the X axis, Y axis and Z axis directions, the plurality of tools are arranged to be located on a circumference whose center coincides with the quill axis of the turret head and to be parallel with the quill axis, and processing work is performed by rotary driving the turret head to rotary index the next working tool to the processing position and advancing/retracting the quill in the quill axis direction. Therefore, the entire machine can be easily downsized to reduce an installation space thereof, and thus plural machines can be installed. Furthermore, mass- production of a small work becomes possible, and thus the productivity of small work can be improved.

### BRIEF DESCRIPTION OF THE DRAWINGS

FIG. 1 is a perspective view of a machining center having a horizontal turret head according to an embodiment of the present invention;

FIG. 2 is a cross-sectional view of the horizontal turret head;

FIG. 3 is a cross sectional view of a tool drive motor of the horizontal turret head;

FIG. 4 is a perspective view of a machining center to which the horizontal turret head is attached;

FIG. 5 is a perspective view of a machining center to which a vertical turret head is attached; and

FIG. 6 is a front view of the vertical turret head.

### DETAILED DESCRIPTION OF THE PREFERRED EMBODIMENTS

Hereinafter, embodiments of the present invention will be described based on the attached drawings.

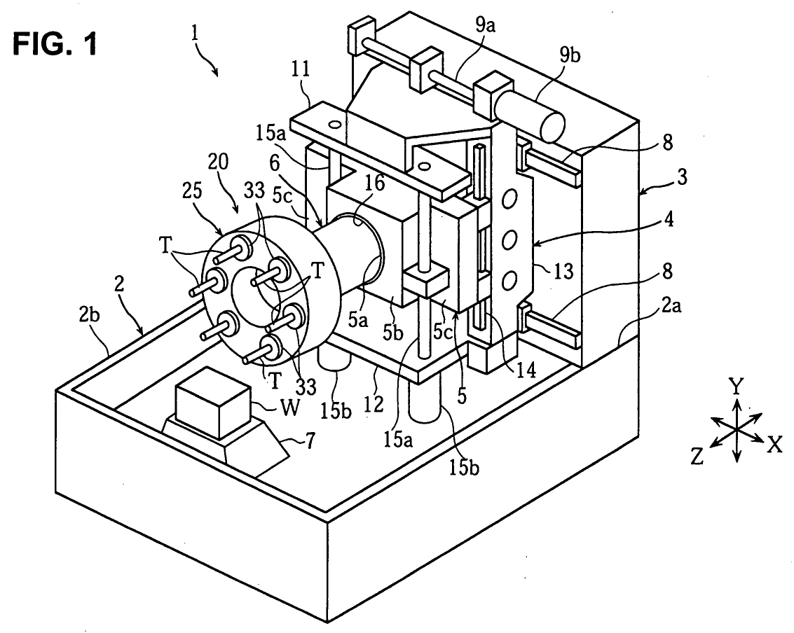

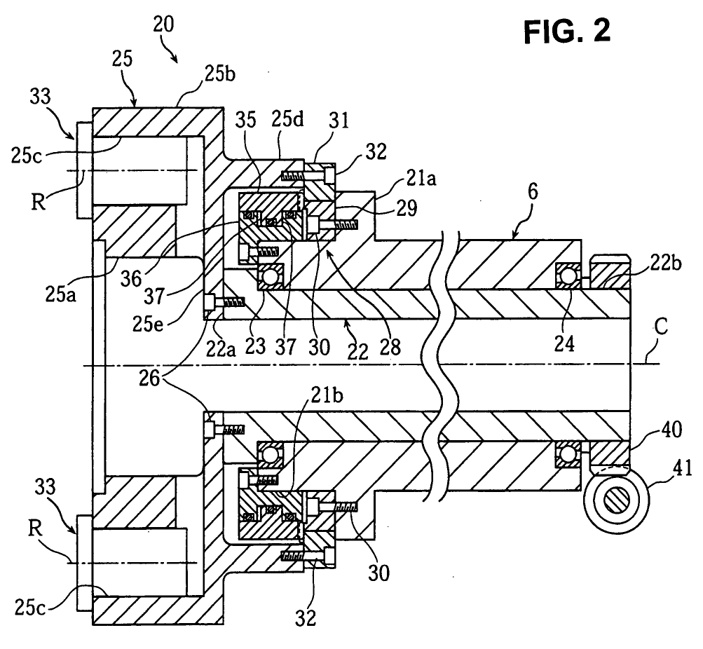

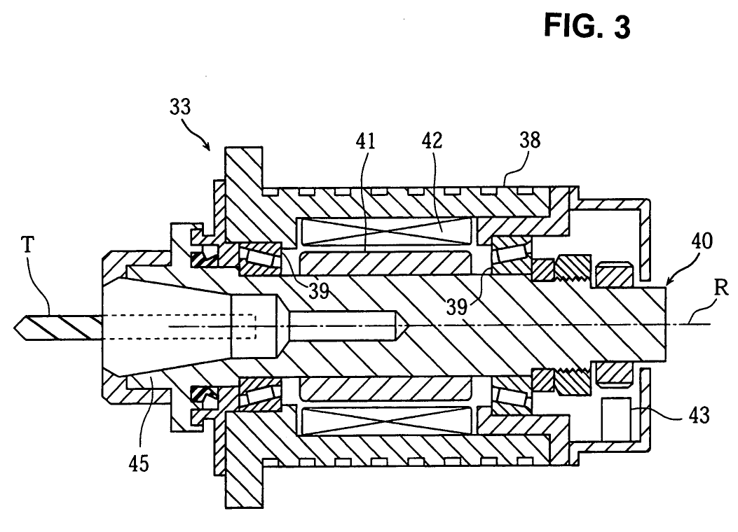

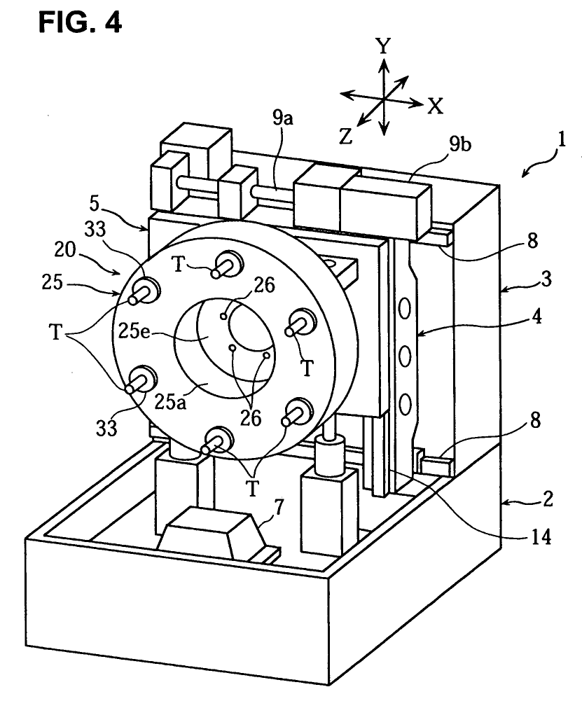

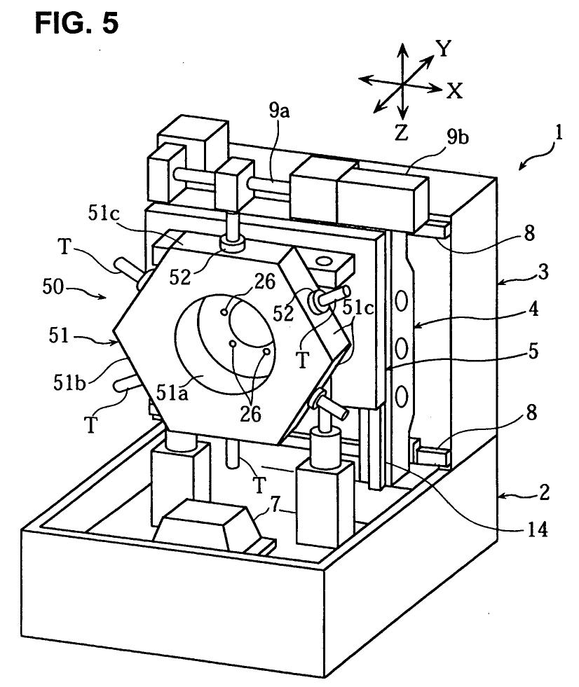

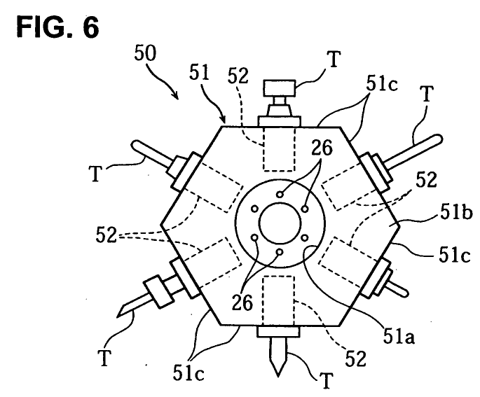

FIG. 1 to FIG. 6 are views for describing a machining center according to an embodiment of a first invention of the present application. FIG. 1 is a perspective view of a machining center having a horizontal turret head, FIG. 2 is a cross-sectional view of the horizontal turret head, FIG. 3 is a cross-sectional view of a tool drive motor, FIG. 4 is a perspective view of the machining center to which the horizontal turret head is attached, FIG. 5 is a perspective view of the machining center to which a vertical turret head is attached, and FIG. 6 is a front view of the vertical turret head.

In the drawings, “1” denotes a machining center having a horizontal turret head 20 to be described later, which is of a desktop type having vertical and horizontal lengths of approximately from 500 mm to 800 mm and a processing stroke of approximately 150 mm in X axis, Y axis and Z axis directions.

The machining center 1 has a schematic structure such that, when seen from the front of the machine, a column 3 extending perpendicularly upward is attached to a rear end portion 2a of a fixed bed 2 in a box shape having a bottom, a saddle 4 is supported by the column 3 to be movable in a left and right (X axis) direction, a turret base 5 is supported by the saddle 4 to be movable in an up and down (Y axis) direction, and a quill 6 is supported by the turret base 5 to be movable in a forward and backward (X axis) direction. On a front end portion 2b of the fixed bed 2, a table 7 on which a work W is mounted is disposed.

The column 3 is formed in a rectangular frame shape having an opening on a center portion thereof. A pair of upper and lower guide rails 8, 8 are disposed on the front surface of the column 3, and the saddle 4 is supported by the respective guide rails 8 to be movable in the X axis direction. The saddle 4 is reciprocated by a ball screw 9a and a servomotor 9b which are disposed on the top surface of the column 3.

The saddle 4 is formed in a frame shape having an opening on a center portion by connecting an upper base 11 and a lower base 12 by left and right support posts 13, 13. On the front surfaces of the left and right support posts 13, guide rails 14 are disposed, and by the left and right guide rails 14, flange portions 5c, 5c of the turret base 5 are supported to be movable in the Y axis direction. The turret base 5 is reciprocated by left and right ball screws 15a, 15a, which are pivotally supported by the upper and lower bases 11, 12, and servomotors 15b, 15b.

The turret base 5 has a structure such that the flange portions 5c, 5c are formed on the left and the right of a base main body 5b that is formed in a substantially rectangular parallelepiped shape extending rearward through the openings of the saddle 4 and the column 3. A sliding hole 5a is formed in the axial core of the base main body 5b, and inside the sliding hole 5a, the quill 6 is inserted to be slidable in the Z axis direction and non-rotatable. The space between the quill 6 and the sliding hole 5a is sealed by a seal member 16. The quill 6 is in a cylindrical shape and having a length covering substantially the entire length of the base main body 5b of the turret base 5, and is reciprocated by a not-shown ball screw and servomotor disposed on the rear side of the column 3.

The horizontal turret head 20 is attached to a front end portion of the quill 6 in an detachable manner. The horizontal turret head 20 has a cylindrical turret shaft 22 inserted into the quill 6 and rotatably supported via bearings 23, 24 and a horizontal turret main body 25 fastened and fixed to the front end surface 22a of the turret shaft 22 by plural bolts 26 in a detachable manner.

The horizontal turret main body 25 has a structure such that plural motor mounting holes 25c are formed at predetermined angular intervals on an outer peripheral portion of a circular drum main body 25b having a recessed portion 25a in its axial core, and a bottom wall portion 25e of the drum main body 25b is attached to the turret shaft 22 by the bolts 26 inserted via the recessed portion 25a. Further, a flange portion 25d in a cylindrical shape projecting rearward is formed on the bottom wall portion 25e.

Tool drive motors 33 are attached to the respective motor mounting holes 25c so that the rotation axis R of them becomes parallel with a quill axis C. Each of the tool drive motors 33 has a structure such that a rotation shaft 40 is inserted in a rotatable and axially unmovable manner via bearings 39, 39 into a housing 38 fixed to the drum main body 25b, a rotor 41 is arranged on the outer peripheral surface of the rotation shaft 40, and a stator 42 is arranged on the inner peripheral surface of the housing 38 so as to oppose the rotor 41. Incidentally, “43” is a sensor to detect the rotation speed and the rotation angle of the rotation shaft 40.

A collet 45 to which a tool T is attached is fixed by tapering engagement to the rotation shaft 40 of each tool drive motor 33. Each tool T is arranged to be located on a circumference, whose center coincides with the quill axis C, on the front end surface of the turret main body 25 and to be parallel with the quill axis C. Thus, the tool drive motor 33 is provided for each tool, and is configured to rotary drive each tool T independently.

A rotary indexing mechanism 28 for rotary indexing and positioning a desired tool T to a predetermined processing position around the quill axis C is disposed on the horizontal turret head 20, and the rotary indexing mechanism 28 has the following structure.

An annular fixed-side coupling 29 is fastened and fixed by bolts 30 to an outer peripheral flange portion 21 a formed on the front end portion of the quill 6. An annular turning-side coupling 31 is arranged coaxially outside the fixed-side coupling 29, and the turning-side coupling 31 is fastened and fixed by bolts 32 on the flange portion 25d of the turret main body 25.

Between the flange portion 25d and a portion in front of the outer peripheral flange portion 21a of the quill 6, an annular coupling 35 having a cross-section in a projecting shape is arranged in a manner capable of axially advancing/retracting between an engagement position for engaging with both the fixed-side and turning-side couplings 29, 31 and an engagement release position for releasing the engagement with both the couplings 29, 31.

This coupling 35 is supported in a manner capable of engaging with a cylinder member 36 having a cross-section in a recessed shape, which is fastened and fixed by bolts on the front end portion 21b of the quill 6, and driven to axially advance/retract by supplying an oil pressure to the oil pressure rooms 37, 37 formed by the coupling 35 and the cylinder member 36.

A worm wheel 40 is fixed on a rear end portion 22b of the turret shaft 22, and a worm gear 41 rotary driven by a not-shown rotary indexing drive motor is engaged with the worm wheel 40.

When the coupling 35 is in an engagement position for engaging with both the fixed-side and turning-side couplings 29, 31, the turret main body is positioned and fixed so that a desired tool T is located at the processing position, and cutting work is performed by the tool T at the processing position.

To index the next working tool to the processing position, the coupling 35 is advanced by an oil pressure to the engagement release position to release the engagement with both the couplings 29, 31. Consequently, the turret shaft 22 and the turret main body 25 become rotatable with respect to the quill 6, and the turret main body 25 is rotated by a rotary indexing motor to rotary index the next working tool to the processing position. When the next working tool is indexed to the processing position, the coupling 35 retracts to the engagement position by the oil pressure to be engaged with both the fixed-side and turning side couplings 29, 31. As a result, the turret main body 25 is positioned and fixed, and the next working tool performs cutting work.

FIG. 5 shows the machining center 1 having a vertical turret head 50, and FIG. 6 shows the vertical turret head 50, respectively. A vertical turret main body 51 of the vertical turret head 50 has a structure such that various tools T are arranged on respective outer wall portions 51c of a hexagonal drum main body 51b having a recessed portion 51a in its axial core so as to form a radial pattern in an orthogonal direction with respect to the above-described quill axis C. A turret shaft (not-shown) of the vertical turret head 50 is common with the turret shaft 22 of the horizontal turret head 20.

Further, tool drive motors 52 to which the respective tools T are attached are fitted into the drum main body 51b in the orthogonal direction with respect to the quill axis C. Incidentally, the basic structure of the tool drive motor is the same as that of the above-described tool drive motor.

In order to replace the horizontal turret head 20 attached to the machining center 1 with the vertical turret head 50, the respective bolts 32 fixing the turning-side coupling 31 are removed, the respective bolts 26 of the recessed portion 25a of the horizontal turret main body 25 are removed, and in this state the horizontal turret main body 25 is removed forward. Next, the vertical turret main body 51 is brought into contact with the tip surface of the turret shaft 22 from the front side, the respective bolts 26 are fastened in the recessed portion 51a, and the respective bolts 32 are fastened on the vertical turret main body 51 to fix the turning-side coupling 31.

Further, in order to attach either the horizontal turret head 20 or the vertical turret head 50 according to a user's request, the turret shaft 22 and rotary indexing mechanism 28 common to the both are assembled to the quill 6, and to these common parts, either the horizontal turret main body 25 or the vertical turret main body 51 is assembled.

Thus, according to this embodiment, either the horizontal turret head 20 or the vertical turret head 50 is attached to the one machining center 1 in a selectively attachable/detachable manner, so that, on the user side, by changing to either the horizontal turret head 20 or the vertical turret head 50 according to the shape of work and the type of processing, the one machining center 1 can correspond to both the horizontal and vertical types. Therefore, the installation space can be reduced, and the installation cost can be lowered as well.

Further, on the maker side, it is only necessary to assemble either the horizontal turret head 20 or the vertical turret head 50 according to the user's order, so that a large percentage of the machining center 1 can be made common, and thus the manufacturing cost can be reduced.

Further, in this embodiment, since the horizontal and vertical turret heads 20, 50 themselves have the structure such that either the horizontal turret main body 25 or the vertical turret main body 51 is selectively attached to the turret shaft 22 that is common to the both, it is only necessary to additionally prepare the respective turret main bodies 25, 51, and thus the horizontal and vertical turret heads themselves can have common parts. Therefore, further cost reduction becomes possible.

Here, in the embodiment, the horizontal and vertical turret heads 20, 50 are made attachable to/detachable from the turret shaft 22, and one of them is selectively attached. However, according to a second invention of the present application, the turret head may be not attachable/detachable, and may be fixedly attached.

With regard to those shown in FIG. 1 to FIG. 4, a machining center constructed by fixedly attaching the horizontal turret head 20 to the turret shaft 22 is a horizontal machining center according to the second invention of the present application.

In the case of this horizontal machining center, tools T are arranged on the front end surface of the turret head 20 in parallel with the quill axis C, and the tools T are advanced/retracted in the direction of the quill axis C to perform processing work. Therefore, as compared to one in which, for example, the tools T are arranged on the outer peripheral surface of the turret head in a radial pattern and the tools are moved radially, the entire machine can be easily downsized, so that an installation space thereof can be made small. Therefore, it is possible to easily increase the number of machines to be installed, and furthermore, mass-production of a small work can be easily carried out.

Further, since the turret head 20 is attached on the front end surface of the quill 6 in a manner capable of rotary indexing a predetermined angular position, and the plural tools T are arranged to be located on a circumference, whose center coincides with the quill axis C, on the turret head 20 in parallel with the quill axis C, the next working tool can be rotary indexed to a processing position only by rotary driving the turret head 20 as described above. Therefore, it is not necessary to change the tools by a conventional automatic tool changer, so that the processing time can be reduced. Consequently, in the case where the mass-production of a small work is carried out, the productivity thereof can be improved.

The invention may be embodied in other specific forms without departing from the spirit or essential characteristics thereof.

The present embodiments are therefore to be considered in all respects as illustrative and no restrictive, the scope of the invention being indicated by the appended claims rather than by the foregoing description, and all changes which come within the meaning and range of equivalency of the claims are therefore intended to be embraced therein.

1. A machining center, comprising:
a bed;
a column fixed on said bed;
a saddle supported by said column to be movable in a left and right (X axis) direction;
a turret base supported by said saddle to be movable in an up and down (Y axis) direction;
a quill supported by said turret base to be movable in a forward and backward (Z axis) direction; and
one of a horizontal turret head and a vertical turret head which are attached to said quill in a selectively attachable/detachable manner,
wherein, on said horizontal turret head, a plurality of tools are arranged to be located on a circumference whose center coincides with a quill axis and to be parallel with the quill axis, and on said vertical turret head, a plurality of tools are arranged to form a radial pattern in an orthogonal direction with respect to the quill axis.

2. The machining center according to claim 1, further comprising a turret shaft that is common to said horizontal turret head and said vertical turret head and supported by said quill in a manner capable of rotary indexing a predetermined position,
wherein either the main body of said horizontal turret head or the main body of said vertical turret head is attached to said turret shaft in a selectively attachable/detachable manner.

3. A machining center, comprising:
a bed;
a column fixed on said bed;
a saddle supported by said column to be movable in a left and right (X axis) direction;
a turret base supported by said saddle to be movable in an up and down (Y axis) direction;
a quill supported by said turret base to be movable in a forward and backward (Z axis) direction; and
a turret head attached to said quill in a manner capable of rotary indexing a predetermined position around a quill axis,
wherein, on said turret head, a plurality of tools are arranged to be located on a circumference whose center coincides with a quill axis and to be parallel with the quill axis.
